(19) United States
(12) Patent Application Publication
(10) Pub. No.: US 2003/0170539 A1
(43) Pub. Date: Sep. 11, 2003

(54) Aqueous electrode binder and electrodes and fuel cells including same

(75) Inventors: David A. Schoonmaker, Newtown, CT (US); Jeffrey P. Allen, Naugatuck, CT (US); Randolph M. Bernard, New Preston, CT (US)

Correspondence Address: BANNER & WITCOFF, LTD., 28 STATE STREET, 28th FLOOR, BOSTON, MA, 02109-9601, US

(73) Assignee: GenCell Corporation, Southbury, CT

(21) Appl. No.: 10/345,073

(22) Filed: Jan. 15, 2003

Related U.S. Application Data
(60) Provisional application No. 60/354,554, filed on Feb. 5, 2002.

(51) Int. Cl. H01M 4/62; H01M 4/86

(52) U.S. Cl. 429/217; 429/42

(57) ABSTRACT

An aqueous binder for making an electrode is provided. The aqueous binder includes water, a polymeric alcohol, a non-polymeric alcohol, a water-soluble resin, a drying moderator, and optionally an anti-foaming agent. The aqueous binder typically includes mostly water such that minimal toxic substances are evolved when the aqueous binder is used to produce electrodes. Electrodes and fuel cells assembled using the aqueous binder are also described.

### BACKGROUND OF THE INVENTION

1. Field of the Invention

Embodiments of the present invention relate to aqueous binder compositions and slurries useful for making electrodes, such as would be useful in fuel cells, such as molten carbonate fuel cells.

2. Description of Related Art

Electrodes, such as those typically used in fuel cells, can be generally formed by combining packed powders with binder solutions that include volatile solvents. The volatile solvents are then evaporated to yield the electrode. Typical solvents used in a binder solution include flammable liquids such as alcohol, methyl ethyl ketone, or cyclohexane, or other such flammable solvents, or combinations of flammable solvents. The release of vapors from the solvent during the drying process presents hazards to the workplace that require systems to contain, collect and either recycle or incinerate the solvents. Release of such vapors to the atmosphere is not desirable due to the potential for combustible vapors coming in contact with unprotected electrical equipment or personnel exposure. Furthermore, local, state, and federal governments regulate air emissions of solvents of these types. Thus, because equipment is required to safely remove the vapors, the overall cost and difficulty of producing electrodes is great. Accordingly, there is a need in the art to avoid the cost and heath hazards associated with the use of volatile solvents in the manufacture of electrodes.

### SUMMARY OF THE INVENTION

Embodiments of the present invention are directed to aqueous compositions and their use in making electrodes. According to one embodiment of the present invention, a composition including water and at least one polymer is provided as an aqueous binder mixture that may be in the form of a solution or suspension. The aqueous binder mixture is typically combined with one or more metals to create a slurry for use in forming an electrode. The aqueous binder mixtures of the present invention are advantageous over prior art binder mixtures because they include water as the major liquid component for the binder mixture, as opposed to volatile solvents which typically are the major liquid component of prior art binder mixtures and which can create health hazards or be difficult or expensive to utilize.

Aqueous binder mixtures according to certain embodiments of the present invention include water in an amount of up to about 80% by weight of a mixture in combination with one or more of a polymeric alcohol, a non-polymeric alcohol, a water-soluble resin, a drying moderator, a water soluble alkali metal salt, and an anti-foaming agent. Other ingredients useful in binder mixtures will be recognized by those of skill in the art based upon the present disclosure.

According to a certain embodiment of the invention, the aqueous binder mixture is prepared by mixing a polymeric alcohol and water to form a first composition. A second composition is made by mixing a non-polymeric alcohol with a water-soluble resin and water. The first and second compositions are then mixed together. One or more of a drying moderator or an anti-foaming agent can then be added if desired. The aqueous binder can be produced in large quantities and stored until needed for electrode manufacturing.

According to one aspect of the present invention, the aqueous binder mixture is combined with one or more metals in powdered form to produce a slurry. The metals are of the type that are useful in electrode manufacture, such as metals commonly known as “transition metals”. The slurry may also include at least one component of an electrolyte system of the fuel cell that will contain the resulting electrode. According to this embodiment, the resulting electrode will be capable of providing the electrolyte component to the electrolyte system should the component be consumed from the electrolyte system during the operation of the fuel cell. For example, if a component of the electrolyte system is consumed by the lithiation of the powdered metal in the electrode, then the electrode will be able to provide the component to the electrolyte system.

The resulting slurry can then be placed into an electrode casting device known to those of skill in the art to produce a cast electrode of desired dimensions. The cast electrode is then typically dried using a drying chamber such as a ventilated chamber, for example, to evaporate the aqueous liquid binder component of the cast electrode. Because the aqueous liquid binder component of the cast electrode includes at least about 80% water, little or no accumulation of other liquid components, such as volatile or toxic liquids, occurs in the ventilated drying chamber. As a result, no solvent collection and/or incineration equipment is needed on the ventilation system of the ventilated drying chamber. After drying, the cast electrode can be inspected for thickness tolerances and/or other desired physical properties.

The electrode resulting from the drying process can then be incorporated into a fuel cell. Depending on the powdered metal particle shape the electrode may require to be densified to achieve the desired porosity of the electrode. For example, certain preferred powdered metals, often powdered metals used to make cathode electrodes, may be comprised of flakes agglomerated into spheres that in turn may be joined into strings with side strings, while other preferred powdered metals, often powdered metals used to make anode electrodes, are comprised of spheres. During tape casting and drying, spherical powders will often densify to the desired end-use density and porosity while flaked powders typically will not fully densify during tape casting and drying due to the irregular shape of the individual particles. In a preferred embodiment of the present invention, the electrode, for example a cathode electrode or optionally an anode electrode is densified while receiving a current collector, such as a current collector disclosed in commonly assigned U.S. Pat. No. 6,383,677, the entire disclosure of which is incorporated herein by reference for all purposes. Typically a calender type rolling mill/current collector applicator device is used to densify the electrode to a densified thickness tolerance. Preferably the densified thickness tolerance is pre-determined to optimize the catalysis of the electrode. The densification of the electrode onto the current collector can provide for a dual-porosity electrode.

One object of the present invention, therefore, is to provide a novel aqueous-based binder formulation for use in making electrodes that avoid the health hazards and difficulties of working with volatile and often toxic solvents in the manufacture of fuel cell electrodes.

Other objects, features and advantages of certain embodiments of the present invention will become more fully apparent from the following description taken in conjunction with the accompanying drawings and claims.

### BRIEF DESCRIPTION OF THE DRAWINGS

In the course of the detailed description of certain preferred embodiments to follow, reference will be made to the attached drawings, in which,

FIG. 1 illustrates a cross-section of an un-fired tape-cast cathode electrode;

FIG. 2 illustrates the relative pore structure of the elements of a molten carbonate fuel cell;

FIG. 3 illustrates an isometric view of a cathode/current collector assembly; and

FIG. 4 illustrates a cross-section of a dual-porosity cathode electrode assembled to a current collector.

### DETAILED DESCRIPTION OF CERTAIN PREFERRED EMBODIMENTS

The principles of the present invention may be applied with particular advantage to provide aqueous-based binder formulations for use in making fuel cell electrodes of all desired configurations. The aqueous-based binder formulations includes one or more of the following ingredients in combination with water: a polymeric alcohol, a non-polymeric alcohol, a water-soluble resin, a drying moderator, a water soluble alkali metal salt, and an anti-foaming agent. Other ingredients useful in binder mixtures will be recognized by those of skill in the art based upon the present disclosure.

According to one aspect of the present invention, the aqueous binder includes at least one polymer suspended in a solvent that is substantially aqueous based, e.g., an aqueous solvent such as water. Typically the polymer is added to the solvent, and the polymer may be suspended in the solvent using numerous methods including, but not limited to, mixing, swirling, agitating, sonicating and the like. In certain embodiments, the polymer may dissolve in the solvent, while in other embodiments the polymer is minimally soluble or insoluble in the solvent. Depending on the nature and physical properties of the polymer, one skilled in the art, given the benefit of this disclosure, will be able to select suitable solvents for suspending a polymer. Exemplary polymers include, but are not limited to, polymeric alcohols such as polyvinyl alcohol. Other suitable polymers will be readily apparent to those skilled in the art, given the benefit of this disclosure.

In accordance with certain preferred embodiments, the largest component of the solvent preferably is water. That is, the largest component of the solvent by weight is water. In certain embodiments, the solvent includes at least about 75% by weight water, more preferably at least about 80% by weight water and most preferably at least about 90% by weight water, e.g., at least about 95% by weight water. It will be recognized by those skilled in the art, given the benefit of this disclosure, that the amount of water present in the solvent will typically depend on the intended use of the solvent and/or the physical properties of the other components to be added to the solvent. For example, when it is desirable to solubilize a first polymer that is freely soluble in water, then the amount of water (by weight) can be high, e.g., greater than 90% by weight. If, however, a second polymer is not as soluble as the first polymer, then the amount of water in the solvent can be reduced, e.g., a solvent including about 75% by weight water can be used in combination with an additional liquid component of the solvent, such as a volatile liquid. It will be within the ability of those skilled in the art, given the benefit of this disclosure, to select suitable amounts of water for including in the solvent of the aqueous binder.

In accordance with certain preferred embodiments, the aqueous binder typically also includes at least one non-polymeric alcohol. The non-polymeric alcohol can be added to the solvent after addition of the polymer, before addition of the polymer or concurrently with addition of the polymer. The non-polymeric alcohols include primary, secondary and tertiary alcohols, which preferably do not include repeating monomeric units. Such non-polymeric alcohols include, but are not limited to, low molecular weight and/or low boiling point hydrocarbon based alcohols, such as methanol, ethanol, propanol, isopropanol, butanol, 2-butyl alcohol, t-butyl alcohol and the like, alcohols having one or more phenyl groups, e.g., phenol, and other alcohols which are non-polymeric. Suitable amounts of non-polymeric alcohol will be readily selected by those skilled in the art given the benefit of this disclosure. Between about 1% and about 5% by weight of non-polymeric alcohol is added to the solvent. The non-polymeric alcohol can be mixed with the other components of the aqueous binder using any of the mixing devices described here, e.g., mechanical mixers, vortexers, ultrasonic mixers, and the like.

In accordance with certain preferred embodiments, the aqueous binder may also include at least one water-soluble resin. The water-soluble resin preferably is a polymeric water-soluble resin including ionic and non-ionic resins that are water-soluble, natural and synthetic resins which are water-soluble, and the like. Resins are considered to be water-soluble if at least about 1 g of the resin dissolves in about 100 mL of water. Numerous useful water-soluble resins are described, for example, in Water-Soluble Resins, Second Edition by Ernest Flick (1991). The water-soluble resin may be a water-soluble polymer resin. Preferably, the water-soluble resin includes a poly(ethylene oxide) resin, such as Polyox® available from Dow Chemical. The water-soluble resins also may include ethylcellulose resins, hydroxyethyl cellulose based resins, cellulose ether based resins, methylacrylate based resins such as hydroxypropyl methyacrylate, e.g., 2-hydroxypropyl methacrylate, phenolic resins, and the like. In certain embodiments a water-soluble resin having an approximate molecular weight of about 100,000 to about 4,000,000 is used. More preferably, a water-soluble resin having an approximate molecular weight, e.g., an average molecular weight, of about 100,000 to about 2,000,000 is used, and most preferably water-soluble resins having an approximate molecular weight from about 100,000 to about 1,000,000 are used, e.g., water-soluble resins having an approximate molecular weight of about 200,000; about 300,000; about 400,000 and/or about 600,000 can be used.

The water-soluble resin can be added to the solvent before the polymer and/or non-polymeric alcohol, after the polymer and/or non-polymeric alcohol, or concurrently with the polymer and/or non-polymeric alcohol. Between about 0.5% and about 3% by weight of water-soluble resin is added to the solvent. The water-soluble resin may be added at any rate to the other components of the aqueous binder, but preferably is added such that minimal clumping occurs. That is, preferably the water-soluble resin is added at a suitable rate such that the aggregation of the water-soluble resin is minimized or prevented. One skilled in the art, given the benefit of this disclosure, will be able to select suitable rates for adding the water-soluble resin to the other components of the aqueous binder disclosed here.

In accordance with certain preferred embodiments, the aqueous binder may also include at least one drying moderator agent, such as glycerol, vegetable oil, or polyethylene glycol. Preferably, the drying moderator is selected such that minimal or no toxic substances evolve during processing of the aqueous binder. The drying moderator acts to promote even drying of the cast to prevent the edge of the drying tape from curling up from the mylar substrate caused by uneven drying. The edge of the tape dries before the center and the edge can shrink and curl up off the mylar when using the Polyox as a binder. Adding drying moderator stops the curling.

The drying moderator may be any suitable drying moderator including, but not limited to, synthetic and natural drying moderators, biopolymers, e.g., xanthans and the like. Preferably, addition of the drying moderator adds flexability to the dried tape and helps to retain the stretchablilty of the binders. The dried tape also can become brittle and difficult to handle in time. The addition of glycerol to the formulation greatly extends the shelf life of the electrodes until an adhesive is applied during flat-wire current collector application. Suitable drying moderators include glycerol, vegetable oil, polyethylene glycol and others known to those skilled in the art. The amount of drying moderator in the slurry is preferably about 0.25% by weight of the slurry. One skilled in the art, given the benefit of this disclosure, will be able to select and add suitable drying moderators.

In accordance with certain preferred embodiments, the aqueous binder may also include at least one anti-foaming agent. The anti-foaming agent is added in a sufficient amount to reduce or minimize foaming, e.g., an effective amount of anti-foaming agent is added. Without wishing to be bound by any particular scientific theory, it is believed that the anti-foaming agent acts to disrupt air pockets in the aqueous binder such that foaming is minimized. The anti-foaming agent can be added at any stage of preparing the aqueous binder, but preferably is added prior to any vigorous mixing such that substantially no air pockets form during mixing of the aqueous binder. Depending on the nature of the components added to the aqueous binder, it will be within the ability of those skilled in the art, given the benefit of this disclosure, to determine if, and when, an anti-foaming agent is required. In certain embodiments, the anti-foaming agent is a non-silicone, non-mineral oil anti-foaming agent. In other embodiments, the anti-foaming agent is petroleum free such that minimal toxic substances evolve during evaporation of the aqueous binder. It will be recognized by those skilled in the art, given the benefit of this disclosure, that the type and nature of the anti-foaming agent selected typically depends on the properties of other components to which the anti-foaming agent is being added. For example, if an anti-foaming agent is to be added to polyvinyl alcohol then a non-silicone anti-foaming agent, that is to say an anti-foaming agent that does not contain silicone such as Foam Blast® 301(S), Foam Blast® 307/307E, Foam Blast® 327, Foam Blast® 338, Foam Blast® 380/380S and/or Foam Blast® 1005 (each available from Ross Chem Inc., Fountain Inn, S.C.) can be added to the polyvinyl alcohol to reduce or prevent foaming. Other anti-foaming agents suitable for an intended use, for example vegetable oil or polyethylene glycol, will be readily selected by those skilled in the art, given the benefit of this disclosure.

In accordance with certain embodiments of the present invention, the water that is used in the solvent preferably is deionized water such that contaminants, e.g., metals, PCB's, and/or pollutants, are not present in the aqueous binder. Such deionized water can be purchased commercially or can be made using deionization methods well known to those skilled in the art, e.g., nanofiltration, chelation, ultrafiltration, distillation, reverse osmosis, etc. In certain embodiments, the deionized water is pure, e.g., it has substantially no ions or other substances and preferably has a resistivity of about 18.2 million ohm-cm and conductivity of about 0.055 microsiemens at 25° C.

In accordance with certain preferred embodiments, the aqueous binder includes 6.4% by weight polymeric alcohol, 3.3% by weight non-polymeric alcohol, 0.6% by weight water-soluble resin, 0.6% by weight drying moderator, 4.1% by weight anti-foaming agent, and 83.3% by weight water. Other amounts will be readily selected by those skilled in the art, however, given the benefit of this disclosure. In accordance with certain preferred embodiments, the aqueous binder includes polyvinyl alcohol as a polymeric alcohol, ethanol as a non-polymeric alcohol, Polyox® as a water-soluble resin, glycerol as a drying moderator and Foamblast® 327 as an anti-foaming agent. Other suitable materials, however, will be apparent to those skilled in the art, given the benefit of this disclosure.

In accordance with certain aspects of the present invention, a method for making an aqueous binder for use in an electrode is provided. In certain embodiments, the method includes combining a polymer and water to form a first solution. The polymer can be added to deionized water in a drop-wise manner, by gross addition of a sample of polymer, or other suitable methods known to those skilled in the art. Preferably, the polymer is added to the deionized water such that minimal or little clumping of the polymer occurs upon addition of the polymer to the deionized water. The polymer and the water can be mixed using any suitable mixing device including, but not limited to, mechanical mixers, ultrasonic mixers, blenders, wisks, and the like. After mixing the polymer and the deionized water for a sufficient time to disperse the polymer in the deionized water, the first solution can be stored until ready for use. A second solution can be made by mixing a non-polymeric alcohol with a water-soluble resin. The second solution can be mixed with water and with the first solution to form the aqueous binder. Alternatively, the second solution can be mixed with water, the first solution and a drying moderator, and the resulting combination can be stored until ready for use. Optionally, an anti-foaming agent can be added to minimize formation of any air pockets during storage of the aqueous binder. The aqueous binder can be stored in any suitable storage vessel, and because the aqueous binder comprises mostly water, no volatile solvent cabinets, devices, etc. are required for storage of the aqueous binder disclosed here.

The aqueous binder can be produced in large quantities and stored until needed. For example, it is possible to mass produce large volumes of the aqueous binder and package the aqueous binder in an amount suitable for use by an end-user, e.g., by a user to produce an electrode. That is, the aqueous binder can be packaged into a suitable volume such that an end-user need only add metal and/or any other suitable materials to form an electrode. Because the aqueous binder includes mostly water, no special precautions are required for packaging the aqueous binder or for using the aqueous binder to produce an electrode. The aqueous binder can be stored in ambient air, e.g., at about 25° C., or at any suitable temperature provided that the solvent of the aqueous binder does not substantially evaporate.

The aqueous binder can be included as part of an electrode kit. The kit may include the aqueous binder, one or more metals for making an electrode, and other suitable materials desired or requested by an end-user. Other suitable materials may include electrolyte components of a fuel cell in which the electrode is intended to be used in, casting devices, and the like. One skilled in the art, given the benefit of this disclosure, will be able to include suitable devices and materials in kits for making electrodes including the aqueous binder.

In accordance with certain aspects of the present invention, an electrode slurry is prepared by mixing together an aqueous binder and at least one metal suitable for electrode use. As discussed above, the aqueous binder typically includes a polymer, a non-polymeric alcohol, a water-soluble resin, a drying moderator, water and optionally an anti-foaming agent. The metal of the electrode slurry typically may be any metal that can conduct current and typically includes those metals referred to as “transition metals” and/or metals that have unfilled orbitals. The metal may also include noble metals such as gold and silver. The metal typically is a solid and can be a powder, e.g., a finely ground powder, or can be in any other suitable form for adding to the aqueous binder. A suitable amount of metal is added such that enough metal is incorporated into the electrode to provide a functional electrode capable of conducting current and/or facilitating chemical reactions. One skilled in the art, given the benefit of this disclosure, will be able to select suitable metals and suitable amounts of metal for incorporation into the electrode disclosed here. Preferably, the metal is nickel or nickel powder, alloys thereof, oxides thereof and/or combinations of the metals and/or alloys thereof and/or oxides thereof.

The electrode slurry may further include a component of the electrolyte system of a fuel cell. In a preferred embodiment where eutectic lithium/potassium carbonate is the electrolyte system, lithium carbonate is incorporated into the electrode slurry to re-supply the electrolyte system of the fuel cell as the lithium is consumed by the lithiation of the electrode during the initial conditioning start-up of the fuel cell. It will be within the ability of those skilled in the art, given the benefit of this disclosure, to select suitable alkali metal salts for incorporation into the electrode disclosed here.

The aqueous binder is typically mixed with at least one metal, and optionally with an alkali metal salt, to form the electrode slurry. The alkali metal salt and the metal can be added in any order to the aqueous binder to form the electrode slurry. The electrode slurry can be stored for extended periods prior to processing the electrode slurry to form an electrode. Because the solvent is aqueous based, no equipment or methods are necessary to recover any volatile solvents or to safely store the electrode slurry. For example, no solvent recovery system or solvent incineration system is necessary because the vapors that evaporate during the processing of the electrode slurry consist mostly of water vapor. One skilled in the art, given the benefit of this disclosure, will be able to select other suitable methods for combining at least one metal and the aqueous binder to form an electrode slurry.

In certain preferred embodiments, the electrode slurry comprises 3% by weight polymeric alcohol, 0.5% by weight non-polymeric alcohol, 0.3% by weight water-soluble resin, 0.3% by weight drying moderator, 49.3% by weight nickel, 40% by weight water, 1.9% by weight anti-foaming agent, and 4.9% lithium carbonate. Such an electrode slurry may be used to form an anode electrode or a cathode electrode, and is particularly well suited for making a cathode.

In other preferred embodiments, the electrode slurry comprising 2.7% by weight polymeric alcohol, 3.6% by weight nonpolymeric alcohol, 2.2% by weight water soluble resin, 0.3% by weight drying moderator, 69.7% by weight nickel-aluminum powder, 19.6% by weight water, and 1.9% by weight anti-foaming agent. Such an electrode slurry may be used to form an anode electrode or a cathode electrode, and is particularly well suited for making an anode.

After combining the metal and the aqueous binder, and optionally the alkali metal salt, the electrode slurry can be degassed if desired. In certain embodiments, the electrode slurry is degassed by slow jar rolling or by application of vacuum. One skilled in the art, given the benefit of this disclosure, will be able to select and use these and other suitable methods for degassing electrode slurries.

The electrode slurry can undergo processing to form an electrode. Such processing typically includes preparing a cast electrode using a casting device and then drying the electrode slurry to form an electrode. The electrode slurry can be formed into a suitable shape or form and dried to provide an electrode using numerous techniques well known to those skilled in the art including but not limited to ventilated drying chambers, ovens and the like. In certain preferred embodiments, the resulting electrode is designed to function as a cathode in a fuel cell, such as a molten carbonate fuel cell, for example. In other preferred embodiments, the resulting electrode is designed to function as an anode in a fuel cell, such as a molten carbonate fuel cell, for example.

In certain embodiments, the electrode slurry is cast using a tape-casting device, such as the tape-casting devices disclosed in U.S. Pat. Nos. 5,473,008, 5,453,101, the entire disclosure of each of which is incorporated herein by reference for all purposes. Tape casting is a manufacturing method utilized to produce packed powder beds of electrodes and electrolyte matrices, for example. Without wishing to be bound by any particular scientific theory, the aqueous binder retains the metals, and the solvent of the aqueous binder will evaporate at room temperature or at slightly elevated temperature. The remaining polymer aqueous binders within the cast will contract to result in an increased packing density of the cast powders. The product of the cast is a bed or sheet of densely packed powder with semi-plastic qualities that promote the handle-ability of the component. The product of the cast has occasionally been referred to as a “green” or “un-fired” tape-cast electrode. The procedure for tape casting typically involves suspending composite materials and a aqueous binder in aqueous or organic solvents and pouring the suspension into a doctor blade reservoir system. A blade opening is typically provided at the bottom of the reservoir and the slip is cast to a uniform height onto a moving substrate. A second blade provides improved dimensional control of the cast tape. The cast suspension passes through a drying section where the solvents evaporate, leaving behind a porous composite. One skilled in the art, given the benefit of this disclosure, will be able to use suitable tape-casting devices, and other devices, such as extruding devices and film deposit devices for casting the electrodes described here.

After casting the electrode slurry, for example using the tape-casting device, the cast electrode typically is dried to remove the water and any low boiling point materials, e.g., the non-polymeric alcohol. Suitable drying temperatures will be readily selected by those skilled in the art, given the benefit of this disclosure, and include, but are not limited to, temperatures of between about 20° C. and about 80° C. Suitable apparatus for drying the cast electrode will also be readily apparent to those skilled in the art, given the benefit of this disclosure, and include, but are not limited to ventilated drying chambers, ovens, reduced pressure chambers, freeze-drying apparatus and the like.

In accordance with certain preferred embodiments, once the electrode is dried, the dried electrode can be inspected for tolerances, such as thickness tolerance, for example. The dried electrode can also be densified while receiving a current collector, for example. Suitable methods for densifying the electrode are known to those skilled in the art and include, but are not limited to, calendering apparatus, milling apparatus, and the methods described in commonly assigned U.S. Pat. No. 6,383,677, the entire disclosure of which is hereby incorporated by reference for all purposes. Preferably, the electrode is densified to a thickness such that optimum porosity and catalysis is achieved. Suitable thicknessess will be readily determined by those skilled in the art, given the benefit of this disclosure. Typically, the density of the electrode material in communication with the current collector is about 15-60% as dense as the metal, e.g., nickel, used to make the electrode, more preferably about 20-55% as dense as the metal used to make the electrode and most preferably about 25-50% as dense as the metal used to make the electrode, for example about 35% as dense as the metal used to make the cathode electrode and about 50% as dense as the metal used to make the anode electrode.

In accordance with certain preferred embodiments, the electrode material that is adjacent to the electrode material in communication with the current collector can be also be densified to a predetermined density. In certain embodiments, the density of the electrode material in communication with the current collector is substantially the same as the density of the electrode material adjacent to the electrode material in communication with the current collector, e.g., the density of the electrode material is substantially uniform throughout the entire electrode. In other embodiments, the electrode material adjacent to the electrode material in communication with the current collector is of a different density, e.g., the density of the electrode material varies throughout the entire electrode. In embodiments where the density of the electrode material varies, a dual-porosity electrode can be produced. Without wishing to be bound by any particular scientific theory, the porosity of the electrode can provide for dynamic equilibrium of electrolyte management between the porous electrodes and the porous electrolyte matrix. Such equilibrium can be achieved by selection of specific pore sizes and the densities distributed among the three elements, that is, the cathode-electrolyte matrix-anode, that comprise a fuel cell's active components. One skilled in the art, given the benefit of this disclosure, will be able to select suitable pore sizes and densities for achieving a desired distribution of the electrolytes present in a fuel cell.

In embodiments that require post-tape-casting densification, such as with cathode electrodes, the density of the electrode material is typically selected using the densification apparatus. For example, a calendering apparatus can be used to set the gap and force to provide a suitable density for the electrode material. Suitable densities will be readily determined or selected by those skilled in the art, given the benefit of this disclosure.

Embodiments of the present invention include a fuel cell including an anode produced using the aqueous binder, an electrolyte matrix, an electrolyte, and a cathode produced using the aqueous binder. As discussed more extensively herein, the anode and cathode preferably are formed by: forming an electrode slurry by combining an aqueous binder and at least one metal, the aqueous binder including at least one polymeric alcohol, at least one non-polymeric alcohol, at least one water-soluble resin, and a drying moderator; forming an electrode by transferring the electrode slurry to a casting device; and drying the cast electrode. The dried cathode electrode typically is densified while receiving a current collector. The dried anode electrode is generally not densified while receiving a current collector. Suitable current collectors typically include, for example, flat-wire current collectors having a first major surface facing toward the electrode and a second major surface facing away from the electrode. The electrode typically is in electrical communication with a major surface of the current collector.

In accordance with certain preferred embodiments, a calender type rolling mill/current collector applicator device can be used to densify the cathode electrode to a specified or predetermined densified thickness tolerance. The densified thickness tolerance is pre-determined to optimize the catalysis of the cathode electrode. The densification of the cathode electrode onto the current collector can provide for a dual-porosity cathode electrode.

In accordance with certain preferred embodiments, the anode of the fuel cell typically can be selected based on the properties and intended function of the fuel cell, e.g., the anode is selected based on the nature and properties of the fuel source of the fuel cell. In embodiments where the fuel cell is a molten carbonate fuel cell, the anode typically is a nickel alloy such as an alloy of nickel and aluminum. However, it will be recognized by those skilled in the art that other suitable anodes can be incorporated into the fuel cells that include the cathode electrode produced using the aqueous binder. Such other suitable anodes will be readily selected by those skilled in the art, given the benefit of this disclosure.

In accordance with certain preferred embodiments, the electrolyte of the fuel cell is also typically selected based on the properties and performance characteristics of the fuel cell. In certain embodiments, the electrolyte is a molten carbonate salt, e.g., in the case of a molten carbonate fuel cell. One skilled in the art, given the benefit of this disclosure, will be able to select suitable electrolytes for incorporation into fuel cells including electrodes produced using the aqueous binder disclosed here.

In accordance with certain preferred embodiments, one or both of the anode and cathode preferably include at least one component of the electrolyte of the fuel cell. Molten carbonate fuel cells, for example, which have electrolytes that typically include a lithium salt, e.g. lithium carbonate, may have a lithium salt incorporated into the anode and cathode. Such incorporation provides for increased performance of the fuel cell because the lithium salt can be incorporated in a suitable amount to anticipate the amount of lithium carbonate that will be consumed during the lithiation of the electrodes of the fuel cell. Such suitable amounts will be readily selected by those skilled in the art, given the benefit of this disclosure.

In accordance with certain embodiments of the present invention, a method of making a fuel cell is provided. The method includes providing an anode, an electrolyte, an electrolyte matrix, and a cathode, in which at least one of the anode and cathode are prepared using the aqueous binder and the methods disclosed here. The anode, cathode, electrolyte, and electrolyte matrix can be assembled as a fuel cell using any suitable apparatus. Typically, after the anode, cathode, electrolyte, and electrolyte matrix are assembled into the fuel cell, the fuel cell is heated to a suitable temperature, for example at least about 300° C., to combust substantially and to vaporize substantially any anti-foaming agent, the polymeric alcohol, any remaining non-polymeric alcohol, the water-soluble resin and the drying moderator of the cast cathode electrode as well as any binders and components of binder systems used to manufacture the anode electrodes and the electrolyte matrix and the electrolyte. In certain embodiments, the fuel cell is heated to its normal operating temperature, e.g., about 650° C. in the case of a molten carbonate fuel cell. Without wishing to be bound by any particular scientific theory, it is believed that the pores of the anode and cathode electrode become at least partially filled with electrolyte, and that the metal of the cathode electrode starts to oxidize when oxygen is initially introduced into the fuel cell when the fuel cell is at a temperature between 300 and 400 degrees centigrade during the initial conditioning procedures of the fuel cell. In certain embodiments, where the electrolyte includes at least one alkali metal salt, the metal of the cathode electrode can by alkalized, e.g., lithiated in the case of a lithium salt, and oxidized simultaneously. In certain embodiments, fuel cells of the carbonate electrolyte type can employ a mechanism where the electrical conductivity of the oxides, created when the oxidant side of the fuel cell is oxidized, is enhanced by alkalization, e.g., lithiation, resulting from contact with the alkali metal, e.g., lithium, provided in the electrolyte system. In certain embodiments, where the electrolyte includes at least one alkali metal salt, the aluminum content of the nickel-aluminum metal of the anode electrode can by alkalized, e.g., lithiated in the case of a lithium salt, and reduced simultaneously. One skilled in the art, given the benefit of this disclosure, will be able to select suitable alkali metals for incorporation into the electrolyte matrix of a fuel cell.

The following examples are illustrative of the aqueous binder, electrodes including the aqueous binder, and fuel cells including electrodes produced using the aqueous binder disclosed here and are not intended to limit the scope of the invention. It will be recognized by those skilled in the art, given the benefit of this disclosure, that numerous steps in the examples may be performed in any order.

### EXAMPLE 1

### Solution Preparation

A first solution is produced by adding polymeric alcohol to deionized water in a ratio of about 8:1 to about 15:1 by weight water/polymeric alcohol. The polymeric alcohol may be any of those discussed here or other suitable polymeric alcohols that will become readily apparent to those skilled in the art, given the benefit of this disclosure. The polymeric alcohol is added to the water at a suitable rate such that clumping of the polymeric alcohol is avoided.

The polymeric alcohol/water solution is covered, is stirred, and is heated to a suitable temperature, e.g., about 60-95° C., for a suitable time, e.g., about 2-4 hours, to produce a translucent solution. The solution is cooled to ambient temperature to produce a clear solution. The solution is stored until ready for use.

A second solution is produced by combining water-soluble resin and non-polymeric alcohol in a ratio of about 2:1 to about 4:1 by weight water-soluble resin/non-polymeric alcohol. About 40-60% of the second solution is added to deionized water. The mixture of the second solution and the deionized water is stilled. The remaining second solution is added to the solution over a 3-8 minute period, e.g., added drop-wise. Preferably, once all the second solution is added to deionized water, the ratio of water/second solution is about 85:1 to about 99:1. The second solution-water combination is covered and is stirred for about 9-18 hours and is stored until ready for use.

### EXAMPLE 2

### Electrode Preparation

An electrode is prepared using the following procedure. A mixing apparatus is placed under a hood, for example, to remove any metal dust generated during preparation of the electrode. The solutions from Example 1 are combined in a ratio of about 1:1 to about 4:1 first solution/second solution-water combination to produce a third solution. Any suitable vessel or apparatus can be used to combine the solutions. A drying moderator is added to the third solution. The ratio of drying moderator to third solution is about 1:50 to about 1:200 depending on the intended use of the electrode. An anti-foaming agent is added to the drying moderator-third solution in a ratio of about 1:20 to about 1:60 anti-foaming agent/drying moderator-third solution.

The anti-foaming agent/drying moderator-third solution is mixed using the mixing apparatus. High purity, e.g., greater than about 99% pure, lithium salt is added to the anti-foaming agent/drying moderator-third solution in a ratio of about 8:1 to about 10:1 lithium salt to anti-foaming agent/drying moderator-third solution. The solution and the lithium salt is mixed at low speed until the lithium salt is fully dispersed in the solution, e.g., fully dispersed on visual observation to produce a dispersed lithium salt solution.

Metal powder is added to the mixing apparatus containing the dispersed lithium salt solution. The metal powder is added at a suitable rate to permit smooth dispersal into the dispersed lithium carbonate solution. The metal powder is added at a ratio of about 1:2, 1:1 or about 2:1 metal powder/dispersed lithium salt solution. Optionally, additional anti-foaming agent can be added to ensure that any air pockets are broken up. The metal powder/dispersed lithium salt solution can be stored until ready for use.

The metal powder/dispersed lithium salt solution is placed onto a mill, e.g., a rolling mill, and degassed. The metal powder/dispersed lithium salt solution is rolled at a suitable speed, e.g., about 5-15 revolutions per minute, for about eight to eighteen hours. The milled metal powder/dispersed lithium salt solution can be stored until ready for use, e.g., can be stored in a suitable storage vessel.

Because the aqueous binder is made mostly of water, no solvent collection and/or incineration equipment is necessary during the preparation of the electrode. The milled metal powder/dispersed lithium salt solution is poured into the hopper of the tape-casting device. The casting blade is set for a desired as-cast thickness of the electrode and the tape-casting device is activated to dispense the milled metal powder/dispersed lithium salt solution into the tape-casting device. The cast electrode is then dried, e.g., in a drying chamber. The dried electrode is removed from the drying chamber and inspected for tolerance, e.g., thickness tolerance. Without wishing to be bound by any particular scientific theory, the water and alcohol is removed during the drying process and the remaining aqueous binder provides bonds between individual particles of metal powder.

### EXAMPLE 3

### Fuel Cell Preparation

The electrode from Example 2 receives a current collector using a calender type rolling mill/current collector applicator device. In the case of a cathode electrode, the cathode electrode is densified while receiving the current collector. The cathode is densified to a thickness selected to optimize the catalysis of the electrode. The densification of the cathode electrode onto the current collector provides a dual-porosity cathode electrode.

The densified cathode electrode is installed as the cathode of a fuel cell, such as a fuel cell including a molten electrolyte, for example. The anode, a suitable electrolyte, and suitable electrolyte matrix are also installed into a fuel cell. Without wishing to be bound by any particular scientific theory, the polymeric alcohol, water-soluble resin and anti-foaming agent using during preparation of the electrode is believed to be vaporized and/or combusted during initial start-up of the fuel cell. When the temperature of a molten carbonate fuel cell is raised to a sufficient temperature such that the electrolyte becomes molten, the pores of the cathode, the pores of the anode, and the pores of the electrolyte matrix will absorb the electrolyte. Without wishing to be bound by any particular scientific theory, it is believed that the lithium salt that was added during electrode preparation combines with the other electrolytes that are commonly used in molten carbonate fuel cell electrolytes. The lithium salt will begin lithiation of the metal powders used to prepare the electrodes as the metal powders of the cathode oxidize and as the metal powders of the anode reduce.

### EXAMPLE 4

### Preparation of a Molten Carbonate Fuel Cell

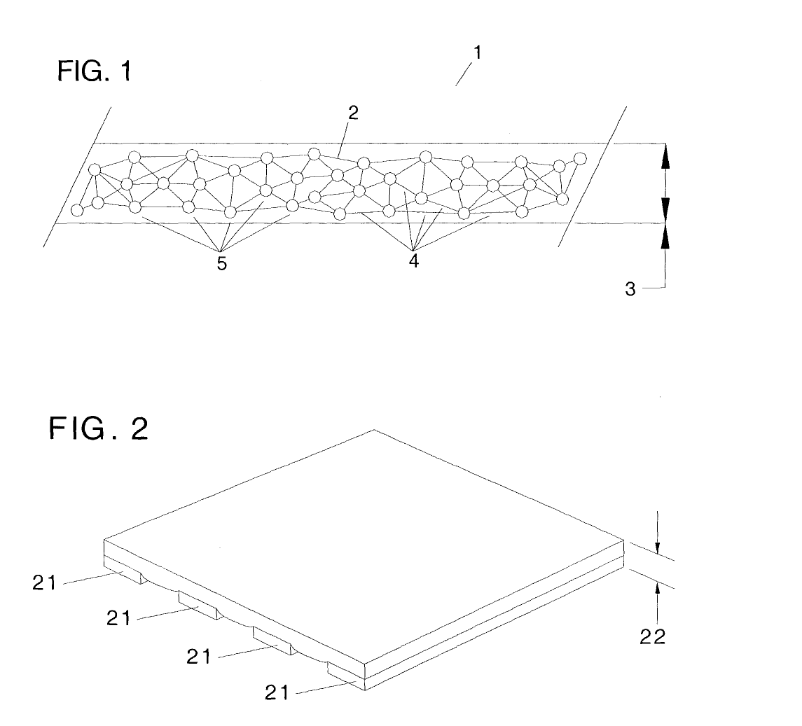

A water based aqueous binder system 2 for the cathode electrode 1 of the MCFC is described and shown in FIG. 1, where a solution of poly vinyl alcohol (PVA) such as PVA supplied from Aldrich Chemical Company, Inc., part number 360627, is prepared by mixing with de-ionized water in a ratio of from 8:1 to 12:1 by weight water/PVA using conventional stirring equipment. The PVA is slowly added to the water to avoid clumping of the PVA. An addition rate of about one to two minutes per 100 grams PVA added to about one liter of water is typically suitable.

The PVA/water solution is covered and is stirred and heated to about 90° centigrade for about three hours to produce a translucent solution. The solution is allowed to cool to ambient temperature while continuing the stirring for about ten to sixteen hours to produce a clear solution. The PVA/water solution is then stored until ready for use.

A water and Polyox® (commercially available as Union Carbide/DOW Chemical part number WSRN205) solution is produced by creating an initial loose slurry of Reagent alcohol such as ethanol and Polyox® in a ratio of about 2.8:1 to 3.2:1 by weight Polyox®/alcohol. About half of the Polyox®/alcohol slurry is quickly added and dispersed into a rapidly stirred vessel containing deionized water. The remaining Polyox® slurry is added within about five minutes. The Polyox® slurry is added in two steps in order to prevent clumping of the Polyox® slurry in the water. The quantity of water in the vessel is in a ratio with the Polyox®/alcohol slurry of about 95:1 to about 99:1 water/Polyox® slurry. The solution is covered and the stir is continued for about ten to sixteen hours. The water/Polyox® solution is then stored until ready for use.

The assembly of the cathode slurry proceeds as follows. A mixing device, such as a KitchenAid® Heavy Duty mixer, is placed under a hood to evacuate nickel dust generated during handling. The PVA solution and the water/Polyox® solution are combined in a vessel that has been placed on a scale, in a ratio of about 2:1 PVA solution/Polyox® solution. Glycerol, such as that commercially available from Aldrich Chemical Company, Inc. as part number 134872, is added to the PVA-Polyox® solutions to a ratio of about 1:165 to about 1:175 glycerol/PVA-Polyox® solution. An anti-foaming agent, such as Foamblast 327, commercially available from Ross Chem Inc., is added to the glycerol-PVA-Polyox® solution in a ratio of about 1:40 to about 1:50 Foamblast 327/glycerol-PVA-Polyox® solution.

The Foamblast 327-glycerol-PVA-Polyox® solution is poured into the mixing bowl of the mixing device. A wire wisk attachment is installed on the mixing device. High purity lithium carbonate, such as high purity lithium carbonate commercially available from Chemetall Foote Corporation, is added to the mixing bowl in a ratio of about 1:9.0 to about 1:9.2 lithium carbonate/Foamblast 327-glycerol-PVA-Polyox® solution. Lithium carbonate is a common component of electrolyte used in molten carbonate fuel cells and is added to the cathode slurry to anticipate that amount of lithium carbonate that will be consumed during the lithiation of the electrodes of the fuel cell. The solution and the lithium carbonate are mixed on low speed for about one minute until the lithium carbonate is fully dispersed in the solution.

Nickel powder 5, such as that commercially available from Inco Special Products as part number Type 255 Nickel Powder, is added to the mixing bowl through a sieve that acts to de-compact the powder 5 that may have been compacted in the shipping container. The nickel powder 5 is added at a rate to the mixer that permits smooth dispersal into the solution while the mixer is operating on slow to medium speed. The nickel powder 5 is added at a ratio of about 1:1 nickel powder/lithium carbonate-foamblast 327-glycerol-PVA-Polyox® solution by weight.

An additional quantity of Foamblast, equal in quantity to the prior addition of Foamblast, is added to the operating mixer at the rate of about ten cubic centimeters per minute over a period of about five minutes. The Foamblast will break-up air pockets within the slurry.

The mixing is continued for about three minutes at medium speed. The completed slurry is transferred to a storage vessel. The storage vessel is placed on a rolling mill to continue de-gassing of the slurry. The slurry is slow rolled at a speed of about ten revolutions per minute for about ten to sixteen hours and thereafter until ready to cast the slurry.

The slurry is poured from the storage vessel into the hopper of the tape-casting device that is commonly used for tape casting of fuel cell electrodes and electrolyte membranes. The casting blade is set for the desired as-cast thickness of the cathode electrode and the tape-casting device is activated to dispense the slurry into the tape-casting device.

Because de-ionized water is used as the primary solvent for the slurry system in a ratio to the secondary alcohol solvent of about 9:1 to about 10:1 water/alcohol, and due to the ventilation rate of the drying chamber that prevents accumulation of alcohol vapors exceeding 25% LEL, solvent collection and/or incineration equipment are not needed on the ventilation system of the drying chamber of the tape-casting device.

As can be seen in FIG. 1, upon completion of the cast and the drying, the tape-cast cathode electrode 1 is removed from the drying chamber and inspected for thickness tolerance 3. The de-ionized water that had been the primary solvent for the aqueous binder system 2 has been removed through a drying process. The Reagent alcohol that had been a secondary solvent for the aqueous binder system 2 has been removed through a drying process. The aqueous binder system 2 can be seen to provide bonds 4 between individual particles of powdered metal 5.

As can be seen in FIG. 2 the accepted tape-cast cathode electrode 1 has been densified while receiving the current collector 21 using a calender type rolling mill/current collector applicator device to a densification and to a densified thickness tolerance 22 pre-determined to optimize the catalysis of the electrode. Typically, the desired density of the densified tape-cast cathode electrode is in the range of about twenty to about twenty-five percent as dense as nickel. The densification of the cathode electrode 1 onto the current collector 21 results in a dual-porosity cathode electrode.

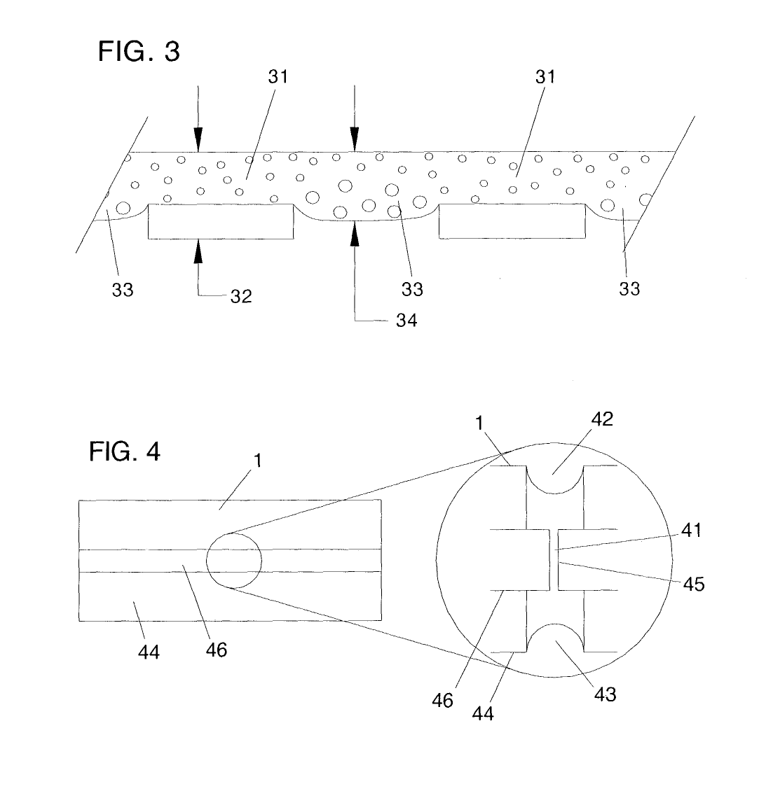

As can be seen in FIG. 3, a portion 31 of cathode electrode 1 adjacent the material comprising current collector 21 is densified to a thickness 32 and density determined by the gap and force set at the calender mill pinch rolls. Cathode electrode 33 adjacent the open area of the current collector 21 is densified to a thickness 34 and density equal to other than that thickness and density of the area adjacent the material comprising the current collector. Thus, a dual-porosity cathode electrode is produced.

Upon installation into the fuel cell, the polyvinyl alcohol, the Polyox®, and the Foamblast comprising the aqueous binders 4 that were used during the preparation of the slurry for the cathode electrode 1, will be combusted during initial pre-conditioning start-up of the fuel cell and the combustion product removed from the fuel cell.

Within FIG. 4, upon elevation of the temperature of the fuel cell to that temperature above which the electrolyte 41 becomes molten, approximately 493° centigrade, the electrolyte 41, that had been stored within the flow field of the fuel cell, will become liquid and be absorbed by the pores 42 of cathode electrode 1 and pores 43 of anode electrode 44 and the pores 45 of electrolyte membrane 46.

The lithium carbonate that had been added to the cathode slurry will combine with the lithium and potassium carbonate electrolytes that are common molten carbonate fuel cell electrolytes. The lithium carbonate will begin lithiation of the nickel powders comprising the cathode electrode as the nickel powders oxidize.

After oxidation and lithiation, the cathode electrode is prepared to function as the catalyst for the oxidation of the cathode reactant gas that is comprised of air and carbon dioxide and water vapor.

Although the present invention has been described above in terms of specific embodiments, it is anticipated that other uses, alterations, substitutions, deletions, and modifications thereof will become apparent to those skilled in the art given the benefit of this disclosure. It is intended that the following claims be read as covering such alterations, substitutions, deletions and modifications as fall within the true spirit and scope of the invention. It is also intended that the steps recited below can be performed in any order unless otherwise clear from the context of the claims.

What is claimed is:

1. An aqueous binder for making an electrode, the aqueous binder comprising:
a polymeric alcohol;
a non-polymeric alcohol;
a water-soluble resin;
a drying moderator; and
water.

2. The aqueous binder of claim 1 further comprising at least one anti-foaming agent.

3. The aqueous binder of claim 1 comprising at least about 70% water.

4. The aqueous binder of claim 1 in which the polymeric alcohol is selected from the group consisting of polyvinyl alcohol, polyethylene glycol, and ethylene glycol ester.

5. The aqueous binder of claim 1 in which the non-polymeric alcohol is selected from the group consisting of methanol, ethanol, isopropanol, propyl alcohol, and butanol.

6. The aqueous binder of claim 1 in which the water-soluble resin is selected from the group consisting of poly(ethylene oxide) resin, and polyethylene glycol.

7. The aqueous binder of claim 1 in which the drying moderator is selected from the group consisting of glycerol, vegetable oil, and polyethylene glycol.

8. The aqueous binder of claim 1 in which the anti-foaming agent is selected from the group consisting of non-silicone anti-foaming agent, vegetable oil, and polyethylene glycol.

9. The aqueous binder of claim 1 comprising 6.5% by weight polymeric alcohol, 1% by weight non-polymeric alcohol, 0.6% by weight water-soluble resin, 0.6% by weight drying moderator, and 88.3% by weight water.

10. The aqueous binder of claim 2 in which the polymeric alcohol is polyvinyl alcohol, the non-polymeric alcohol is ethanol, the water-soluble resin is poly(ethylene oxide) resin, the drying moderator is glycerol, and the anti-foaming agent is non-silicone anti-foaming agent.

11. An electrode slurry comprising:
an aqueous binder comprising a polymeric alcohol, a non-polymeric alcohol, a water-soluble resin, a drying moderator, and water; and
at least one metal admixed with the aqueous binder.

12. The electrode slurry of claim 10 further comprising at least one alkali metal salt admixed with the aqueous binder and the at least one metal.

13. The electrode slurry of claim 12 in which the alkali metal salt is lithium carbonate.

14. The electrode slurry of claim 11 in which the at least one metal is selected from the group consisting of nickel, nickel alloys, platinum, platinum alloys, and mixed metal oxides.

15. The electrode slurry of claim 11 in which the polymeric alcohol is polyvinyl alcohol.

16. The electrode slurry of claim 11 in which the water-soluble resin is poly(ethylene oxide) resin.

17. The electrode slurry of claim 11 in which the drying moderator is glycerol.

18. The electrode slurry of claim 11 in which the electrode slurry comprises at least about 70% water.

19. The electrode slurry of claim 11 in which the polymeric alcohol is polyvinyl alcohol, the non-polymeric alcohol is ethanol, the water-soluble-resin is poly(ethylene oxide) resin, the drying moderator is glycerol, and the at least one metal comprises nickel.

20. The electrode slurry of claim 11 comprising 3% by weight polymeric alcohol, 0.5% by weight non-polymeric alcohol, 0.3% by weight water-soluble resin, 0.3% by weight drying moderator, 49.3% by weight nickel, 40% by weight water, 1.9% anti-foaming agent, and 4.9% lithium carbonate.

21. The electrode slurry of claim 11 comprising 2.7% by weight polymeric alcohol, 3.6% by weight nonpolymeric alcohol, 2.2% by weight water soluble resin, 0.3% by weight drying moderator, 69.7% by weight nickel-aluminum powder, 19.6% by weight water, and 1.9% by weight anti-foaming agent.

22. The electrode slurry of claim 11 in which the aqueous binder further comprises at least one anti-foaming agent.

23. A method of producing an aqueous binder for making an electrode, the method comprising
forming a first solution by combining water with at least one polymeric alcohol;
forming a second solution by combining at least one non-polymeric alcohol with at least one water-soluble resin; and
forming a slurry by combining the first and second solutions with a drying moderator and water.

24. The method of claim 23 further comprising adding at least one anti-foaming agent to the slurry.

25. The method of claim 24 further comprising mixing the first solution, the second solution, the drying moderator, and the anti-foaming agent using a mixing apparatus.

26. The method of claim 25 in which the mixing apparatus is a mechanical mixer, an ultrasonic mixer, or a vortexer.

27. The method of claim 23 in which the polymeric alcohol is polyvinyl alcohol, the non-polymeric alcohol is ethanol, the water-soluble resin is poly(ethylene oxide) resin, the drying moderator is glycerol, and the anti-foaming agent is non-silicone anti-foaming agent.

28. The method of claim 27 in which the slurry comprises an aqueous binder comprising 6.5% by weight polyvinyl alcohol, 1% by weight ethanol, 0.6% by weight poly(ethylene oxide) resin, 0.6% by weight glycerol, and 88% by weight water.

29. The method of claim 23 further comprising adding at least one alkali metal salt to the slurry.

30. The method of claim 29 in which the alkali metal salt is lithium carbonate.

31. A method of manufacturing an electrode slurry, the method comprising
forming an aqueous binder by:
combining water, at least one polymeric alcohol, at least one non-polymeric alcohol, at least one water-soluble resin, and a drying moderator,
combining the aqueous binder with at least one metal to the slurry to form the electrode slurry.

32. The method of claim 31 further comprising degassing the electrode slurry.

33. The method of claim 32 further comprising transferring the electrode slurry to a tape-casting device to form a tape-cast electrode.

34. The method of claim 33 further comprising drying the tape-cast electrode in a drying apparatus to remove solvents of the electrode slurry.

35. The method of claim 34 further comprising transferring the dried tape-cast electrode to a current collector applicator/densifying device.

36. The method of claim 35 further comprising applying the current collector and densifying the tape-cast electrode.

37. The method of claim 31 further comprising adding lithium carbonate to the electrode slurry.

38. The method of claim 31 in which the metal is selected from the group consisting of nickel, nickel alloys, platinum, platinum alloys, and mixed metal oxides.

39. The method of claim 31 in which the polymeric alcohol is polyvinyl alcohol, the non-polymeric alcohol is ethanol, the water-soluble resin is poly(ethylene oxide) resin, the drying moderator is glycerol, the anti-foaming agent is non-silicone anti-foaming agent, and the metal is nickel powder.

40. The method of claim 39 comprising 3% by weight polymeric alcohol, 0.5% by weight non-polymeric alcohol, 0.3% by weight water-soluble resin, 0.3% by weight drying moderator, 1.9% by weight anti-foaming agent, 49.3% by weight nickel, and 40% by weight water.

41. The method of claim 39 comprising 2.7% by weight polymeric alcohol, 3.6% by weight nonpolymeric alcohol, 2.2% by weight water soluble resin, 0.3% by weight drying moderator, 69.7% by weight nickel-aluminum powder, 19.6% by weight water, and 1.9% by weight anti-foaming agent.

42. A method of manufacturing an electrode, the method comprising:
combining an aqueous binder and at least one metal to form an electrode slurry, the aqueous binder comprising water, at least one polymeric alcohol, at least one non-polymeric alcohol, at least one water-soluble resin, and a drying moderator;
casting an electrode by transferring the electrode slurry to a casting device; and
drying the cast electrode.

43. The method of claim 42 in which the electrode slurry further comprises at least one alkali metal salt.

44. The method of claim 42 in which the electrode slurry is milled prior to transferring the electrode slurry to the casting device.

45. The method of claim 42 further comprising densifying the dried electrode onto a current collector.

46. The method of claim 42 in which the cast electrode is dried using a drying chamber selected from the group consisting of an oven, hood, and vented duct.

47. The method of claim 42 in which the aqueous binder and the at least one metal are mixed using a mixing apparatus prior to transferring the electrode slurry to the tape-casting device.

48. The method of claim 47 in which the mixing apparatus is selected from the group consisting of mechanical mixers, ultrasonic mixers and vortexers.

49. The method of claim 42 in which the electrode slurry further comprises at least one-anti-foaming agent.

50. The method of claim 42 in which the aqueous binder comprises polyvinyl alcohol as the polymeric alcohol, ethanol as the non-polymeric alcohol, poly(ethylene oxide) resin as the water-soluble resin, and glycerol as the drying moderator.

51. The method of claim 42 in which the casting device is selected from the group consisting of tape-casting devices, extruding devices, and film deposit devices.

52. A fuel cell comprising:
an anode electrode;
an electrolyte in communication with the anode;
a cathode electrode in communication with the electrolyte wherein at least one of the anode electrode and the cathode electrode is produced by
forming an electrode slurry by combining an aqueous binder and at least one metal, the aqueous binder comprising water, at least one polymeric alcohol, at least one non-polymeric alcohol, at least one water-soluble resin, and a drying moderator;
forming an electrode by transferring the electrode slurry to a casting device; and
drying the cast electrode.

53. The fuel cell of claim 52, wherein the anode electrode is produced by
forming an electrode slurry by combining an aqueous binder and at least one metal, the aqueous binder comprising water, at least one polymeric alcohol, at least one non-polymeric alcohol, at least one water-soluble resin, and a drying moderator;
forming an electrode by transferring the electrode slurry to a casting device; and
drying the cast electrode.

54. The fuel cell of claim 52, wherein the cathode electrode is produced by
forming an electrode slurry by combining an aqueous binder and at least one metal, the aqueous binder comprising water, at least one polymeric alcohol, at least one non-polymeric alcohol, at least one water-soluble resin, and a drying moderator;
forming an electrode by transferring the electrode slurry to a casting device; and
drying the cast electrode.

55. The fuel cell of claim 52, wherein both the anode electrode and the cathode electrode are produced by
forming an electrode slurry by combining an aqueous binder and at least one metal, the aqueous binder comprising water, at least one polymeric alcohol, at least one non-polymeric alcohol, at least one water-soluble resin, and a drying moderator;
forming an electrode by transferring the electrode slurry to a casting device; and
drying the cast electrode.

56. The fuel cell of claim 52 in which the casting device is selected from the group consisting of tape-casting devices, extruding devices, and film deposit devices.

57. The fuel cell of claim 52 in which the cathode electrode is in communication with a current collector.

58. The fuel cell of claim 52 in which the anode electrode is nickel.

59. The fuel cell of claim 52 in which the electrolyte is 62% lithium carbonate and 38% potassium carbonate.

60. The fuel cell of claim 52 in which the polymeric alcohol is polyvinyl alcohol, the non-polymeric alcohol is ethanol, the water-soluble resin is Poly(ethylene oxide) resin, and the drying moderator is glycerol.

61. The fuel cell of claim 52 in which the aqueous binder further comprises an anti-foaming agent.

62. The fuel cell of claim 52 in which the electrode slurry comprises at least one component present in the electrolyte.

63. The fuel cell of claim 62 in which the at least one component present in the electrolyte is lithium carbonate.

64. The fuel cell of claim 52 in which the electrode slurry is milled and degassed prior to transferring the electrode slurry to the casting device.

65. A method of making a fuel cell, the method comprising:
providing an anode electrode, an electrolyte and a cathode electrode, at least one of the anode electrode and the cathode electrode produced by:
combining an aqueous binder and at least one metal to form an electrode slurry, the aqueous binder comprising water, at least one polymeric alcohol, at least one non-polymeric alcohol, at least one water-soluble resin, and a drying moderator,
casting an electrode by transferring the electrode slurry to a casting device to form a cast electrode, and
drying the cast electrode; and
heating the fuel cell to a suitable temperature to combust substantially and to vaporize substantially the anti-foaming agent, the polymeric alcohol, the non-polymeric alcohol, the water-soluble resin and the drying moderator of the cast cathode electrode.

66. The method of claim 65 further comprising partially filling the pores of the cast electrode with electrolyte prior to heating the fuel cell.

67. The method of claim 65 in which the fuel cell is heated to at least about 300° C. to combust substantially and to vaporize substantially the anti-foaming agent, the polymeric alcohol, the non-polymeric alcohol, the water-soluble resin and the drying moderator of the cast cathode electrode.

68. The method of claim 65 in which the anode electrode comprises nickel.

69. The method of claim 65 in which the electrolyte is 62% lithium carbonate and 38% potassium carbonate.

70. The method of claim 65, wherein each of the anode electrode and the cathode electrode are produced by:
combining an aqueous binder and at least one metal to form an electrode slurry, the aqueous binder comprising water, at least one polymeric alcohol, at least one non-polymeric alcohol, at least one water-soluble resin, and a drying moderator,
casting an electrode by transferring the electrode slurry to a casting device to form a cast electrode, and
drying the cast electrode.

71. The method of claim 65, wherein the anode electrode is produced by:
forming an electrode slurry by combining an aqueous binder and at least one metal, the aqueous binder comprising water, at least one polymeric alcohol, at least one non-polymeric alcohol, at least one water-soluble resin, and a drying moderator;
forming an electrode by transferring the electrode slurry to a casting device; and
drying the cast electrode.

72. The method of claim 65, wherein the cathode electrode is produced by:
forming an electrode slurry by combining an aqueous binder and at least one metal, the aqueous binder comprising water, at least one polymeric alcohol, at least one non-polymeric alcohol, at least one water-soluble resin, and a drying moderator;
forming an electrode by transferring the electrode slurry to a casting device; and
drying the cast electrode.
